(19) United States
(12) Patent Application Publication
(10) Pub. No.: US 2019/0045329 A1
(43) Pub. Date: Feb. 7, 2019

(54) APPARATUS AND METHOD TO ESTIMATE A POSITION OF A TERMINAL IN A FACILITY HAVING MULTIPLE FLOORS

(71) Applicant: FUJITSU LIMITED, Kawasaki-shi (JP)

(72) Inventors: Kota Natsume, Ota (JP); Gensai Hideshima, Nishinomiya (JP); Kaori Suyama, Fuchu (JP); Fumiaki Nakamura, London (GB); Etsushi Fujita, Kawasaki (JP)

(73) Assignee: FUJITSU LIMITED, Kawasaki-shi (JP)

(21) Appl. No.: 16/154,982

(22) Filed: Oct. 9, 2018

Related U.S. Application Data
(63) Continuation of application No. PCT/JP2016/061742, filed on Apr. 11, 2016.

(51) Int. Cl. H04W 4/02; H04W 4/33; G01C 21/20; H04W 64/00

(52) U.S. Cl. CPC H04W 4/027; H04W 64/006; G01C 21/206; H04W 4/33

(57) ABSTRACT

An apparatus determines a plurality of candidate position groups each indicating an trajectory of estimated terminal positions on a candidate floor selected from among multiple floors, wherein the trajectory of estimated terminal positions on the candidate floor is estimated based on positions of base stations installed on the candidate floor and intensities of radio waves that have been transmitted by a terminal at time points and detected by the base stations. The apparatus identifies, from among the candidate floors selected from the multiple floors, a target floor on which the terminal actually exists, based on the trajectories of estimated terminal positions for the determined plurality of candidate position groups and a movement requirement that defines a condition of actual movement of the terminal on each of the candidate floors.

### CROSS-REFERENCE TO RELATED APPLICATION

This application is a continuation application of International Application PCT/JP2016/061742 filed on Apr. 11, 2016 and designated the U.S., the entire contents of which are incorporated herein by reference.

### FIELD

The embodiments discussed herein are related to apparatus and method to estimate a position of a terminal in a facility having multiple floors.

### BACKGROUND

A wireless local area network (LAN) to which a terminal is connected via wireless communication is known (refer to, for example, Japanese Laid-open Patent Publication No. 2001-216450). A base station of the wireless LAN wirelessly transmits, at fixed time intervals, a signal or radio wave (hereinafter merely referred to as radio wave) that is referred to as beacon, and the terminal may measure the intensity (hereinafter referred to as radio wave intensity) of the radio wave. A position estimating device that estimates the position of the terminal based on the radio wave intensity transmitted by the terminal and a registered position of the base station is known (refer to, for example, Japanese Laid-open Patent Publication No. 2012-151543).

### SUMMARY

According to an aspect of the embodiments, an apparatus determines a plurality of candidate position groups each indicating an trajectory of estimated terminal positions on a candidate floor selected from among multiple floors, wherein the trajectory of estimated terminal positions on the candidate floor is estimated based on positions of base stations installed on the candidate floor and intensities of radio waves that have been transmitted by a terminal at time points and detected by the base stations. The apparatus identifies, from among the candidate floors selected from the multiple floors, a target floor on which the terminal actually exists, based on the trajectories of estimated terminal positions for the determined plurality of candidate position groups and a movement requirement that defines a condition of actual movement of the terminal on each of the candidate floors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an example of a position estimation system;

FIG. 2A illustrates an example of a zone layout of a first floor;

FIG. 2B illustrates an example of a zone layout of a second floor;

FIG. 3 illustrates an example of a hardware configuration of a floor identifying server;

FIG. 4 illustrates an example of a functional block diagram of the floor identifying server;

FIG. 5 illustrates an example of property information;

FIG. 6 illustrates an example of rule information;

FIG. 7 illustrates an example of device information;

FIG. 8 is a flowchart illustrating an example of a process to be executed by an information processing unit;

FIG. 9 is a flowchart illustrating an example of another process to be executed by the information processing unit;

FIG. 10A illustrates an example of a movement of a device on a first floor;

FIG. 10B illustrates an example of a movement of the device on a second floor;

FIG. 11A illustrates a trajectory of positional coordinates of the device detected by access points installed on the first floor;

FIG. 11B illustrates a trajectory of positional coordinates of the device detected by access points installed on the second floor;

FIG. 12 is a flowchart illustrating an example of operations of a floor identifying unit;

FIG. 13 illustrates an example of information to be analyzed;

FIG. 14 is a flowchart illustrating an example of a floor identification process;

FIGS. 15A and 15B are diagrams describing examples of an analysis range A;

FIG. 16 is a diagram describing an example of time when the device is moved between floors;

FIGS. 17A and 17B are diagrams describing an example of an analysis range B;

FIG. 18 illustrates an example of device information of identified floors;

FIG. 19 illustrates an example of device information in which processed flags are registered;

FIG. 20 is a flowchart exemplifying a part of the floor identification process;

FIGS. 21A and 21B illustrate examples of scatter diagrams illustrating relationships between detection time in the analysis range A and radio wave intensities; and

FIGS. 22A and 22B illustrate examples of scatter diagrams illustrating relationships between detection time in the analysis range B and radio wave intensities.

### DESCRIPTION OF EMBODIMENTS

When the position of a terminal is to be estimated in a facility in which base stations are installed on multiple stories (hereinafter referred to as floors), the position of the terminal may not be accurately estimated due to structural factors of the facility. As an example, in a certain case, a portion of a ceiling on the first floor may be open up to the second floor due to a two-story ceiling, depending on the facility. In this case, even when a terminal exists on the first floor, the terminal may measure a radio wave intensity of a base station installed on the second floor and a radio wave intensity of a base station installed on the first floor, and the measured radio wave intensity of the base station installed on the second floor may be higher than the measured radio wave intensity of the base station installed on the first floor. Thus, the terminal may be erroneously estimated as a terminal existing on the second floor.

It is preferable to accurately estimate the position of a terminal and a floor on which the terminal exists even in a facility in which multiple floors exist.

Hereinafter, embodiments disclosed herein are described with reference to the accompanying drawings.

### First Embodiment

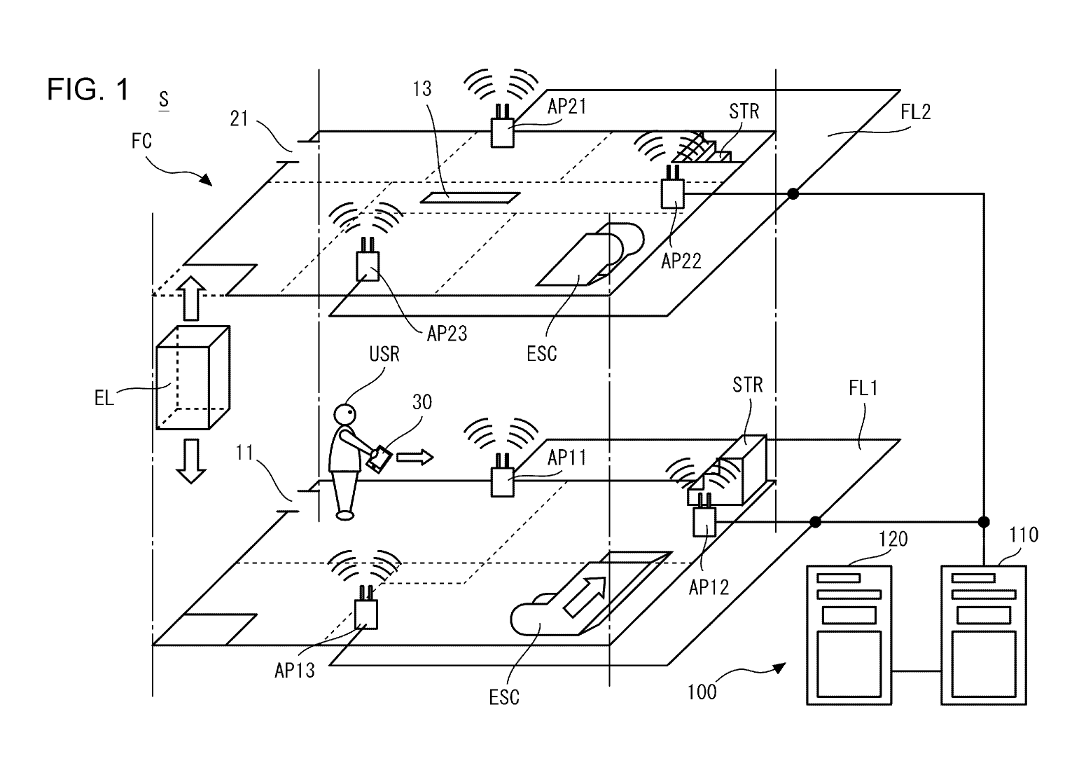

FIG. 1 is a diagram describing an example of a position estimation system S. The position estimation system S may be used in a facility FC having multiple floors FL1 and FL2. For example, as the facility FC, a commercial facility such as a store, a school facility such as a school building, a medical facility, an amusement facility, an office building, or the like is used. For example, as the floors FL1 and FL2, first and second floors, third and fourth floors, first and second basements, or the like are used. In the first embodiment, the floors FL1 and FL2 are the first and second floors. In addition, although described in detail later, each of the floors FL1 and FL2 is segmented into multiple sections (hereinafter referred to as zones). Entrances 11 and 21 through which a person enters into and leaves the facility FC are installed in zones among the zones. In the first embodiment, as illustrated in FIG. 1, the entrances 11 and 21 are installed in the specific zones on the first and second floors, respectively.

In addition, various facilities that enable a person to move between the floors are installed in zones among the zones. In the first embodiment, as illustrated in FIG. 1, facilities such as an elevator EL, an escalator ESC, and stairs STR are installed in specific zones. Thus, a user USR who stays in the facility FC may use the facilities to move from the first floor to the second floor and from the second floor to the first floor in the facility FC.

Furthermore, a two-story ceiling, a staircase landing, a mezzanine between the first second FL1 and the second floor FL2, decorative object that decorate the inside of the facility FC, and the like may be installed, depending on the zones. In the first embodiment, as illustrated in FIG. 1, a portion of a ceiling on the first floor is open up to the second floor due to a two-story ceiling 13 installed in a specific zone.

As illustrated in FIG. 1, the position estimation system S includes multiple base stations (hereinafter referred to as access points) AP11 to AP13 and AP21 to AP23 and a position estimating device 100. The access points AP11 to AP13 are installed at different positions on the first floor, for example. The access points AP21 to AP23 are installed at different positions on the second floor, for example. Each of the access points AP11 to AP13 and AP21 to AP23 transmits a radio wave at fixed time intervals. The radio waves may pass through the two-story ceiling 13, the ceiling of the facility FC, walls of the facility, the decorative objects, and the like. Thus, for example, a terminal (hereinafter referred to as device) 30 held by the user USR staying on the first floor may measure the intensities of radio waves transmitted by the access points AP11 to AP13 and AP21 to AP23. In addition, the device 30 positioned outside the facility FC may measure the intensities of radio waves transmitted by the access points AP11 to AP13 and AP21 to AP23. For example, as the device 30, a smart device such as a smartphone, a smartwatch, or a tablet terminal may be used.

Each of the access points AP11 to AP13 and AP21 to AP23 may detect the device 30. Specifically, when the device 30 measures radio wave intensities, the device 30 transmits a device ID given to the device 30, the measured radio wave intensities, and the like to the access points A11 to A13 and A21 to A23. Although described later in detail, the device ID is identification information identifying the device 30. The access points AP11 to AP13 and AP21 to AP23 detect the device 30 by detecting the device ID transmitted by the device 30, the radio wave intensities transmitted by the device 30, and the like.

The aforementioned position estimating device 100 includes a database (DB) server 110 and a floor identifying server 120. The DB server 110 is coupled directly or indirectly to the access points AP11 to AP13 and AP21 to AP23. Thus, the DB server 110 may acquire radio wave intensities, the device ID, and the like from the device 30. Specifically, the DB server 110 may acquire the radio wave intensities detected by the access points AP11 to AP13 and AP21 to AP23, the device ID detected by the access points AP11 to AP13 and AP21 to AP23, and detection time when the device 30 has been detected. The DB server 110 estimates positional coordinates of the device 30 based on the acquired radio wave intensities and positional coordinates, registered in the DB server 110, of the access points AP11 to AP13 and AP21 to AP23.

The floor identifying server 120 uses the positional coordinates estimated by the DB server 110 to identify any of the floors FL1 and FL2 on which the device 30 exists. Specifically, the floor identifying server 120 identifies any of the floors FL1 and FL2 on which the device 30 exists, based on rule information for each of the multiple floors FL1 and FL2 and trajectories on the floors FL1 and FL2 that are indicated by candidate groups in the cases where the device 30 exists on the multiple floors FL1 and FL2, respectively, among candidate groups indicating positions, estimated by the DB server 110 at multiple time points, of the device 30. The rule information indicates requirements defining whether or not the device 30 is permitted to be moved. The rule information is described in detail later.

Although the functions of the DB server 110 and the functions of the floor identifying server 120 are simply described above, detailed functions and operations of the DB server 110 and detailed functions and operations of the floor identifying server 120 are described later. The access points AP11 to AP13 and AP21 to AP23, the DB server 110, and the floor identifying server 120 may be installed in the same communication network. Alternatively, one or more of the access points AP11 to AP13 and AP21 to AP23, the DB server 110, and the floor identifying server 120 may be installed in a communication network different from a communication network in which the other of the access points AP11 to AP13 and AP21 to AP23, the DB server 110, and the floor identifying server 120 are installed. For example, the DB server 110 and the floor identifying server 120 may be installed in a data center included in a cloud.

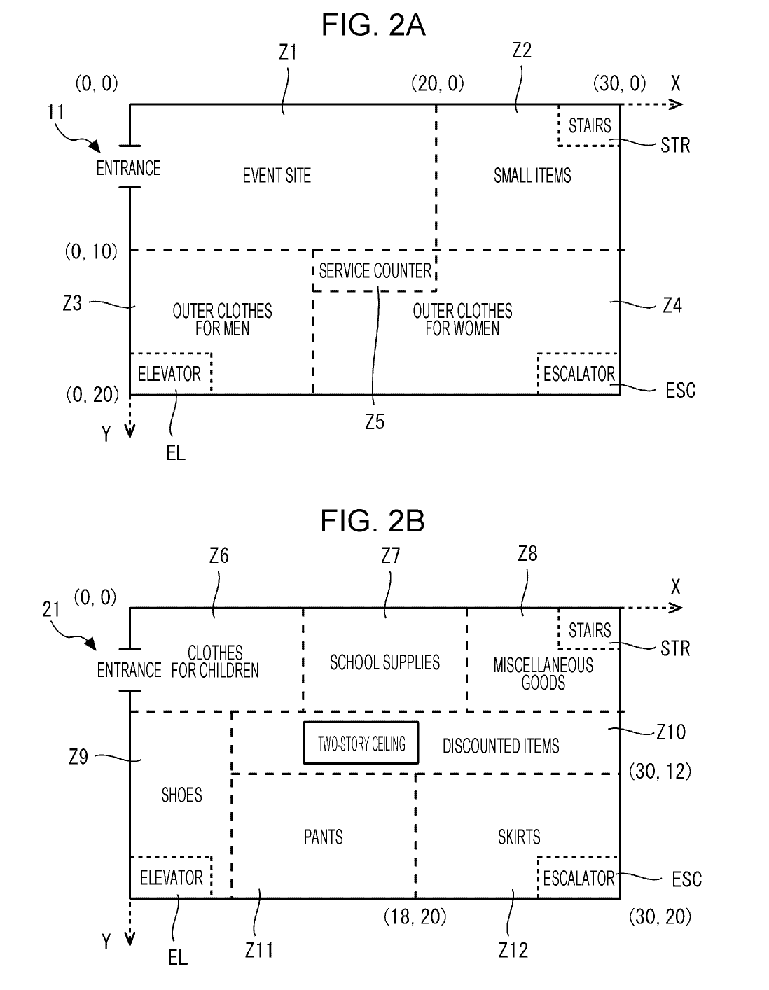

Next, the aforementioned zones are described in detail with reference to FIGS. 2A and 2B.

FIG. 2A illustrates an example of a zone layout of the first floor. FIG. 2B illustrates an example of a zone layout of the second floor. As illustrated in FIG. 2A, the first floor is sectioned into multiple zones Z1 to Z5. The zone Z1 is, for example, used as an event site, and the entrance 11 exists in the zone Z1. The zone Z2 is, for example, used as a selling space for small items such as wallets and commuter pass holders, and stairs STR exist in the zone Z2. The zone Z3 is, for example, used as a selling space for outer clothes for men, and an elevator EL exists in the zone Z3. The zone Z4 is, for example, used as a selling space for outer clothes for women, and an escalator ESC exists in the zone Z4. The zone Z5 is, for example, used as a service counter, and the entrances 11 and 21 and the facilities for enabling the device 30 to be moved between the floors do not exist in the zone Z5. Each of the zones Z1 to Z5 is defined by positional coordinates indicating a specific position (for example, any of four corners) as the origin of the zone. For example, the zone Z1 is defined to be in a range of positional coordinates (0, 0) to positional coordinates (20, 10) on the first floor.

As illustrated in FIG. 2B, the second floor is sectioned into multiple zones Z6 to Z12. The zone Z6 is, for example, used as a selling space for clothes for children, and the entrance 21 exists in the zone Z6. The zone 7 is, for example, used as a selling space for school supplies such as bags and stationaries for children, and the entrances 11 and 21 and the facilities for enabling the device 30 to be moved between the floors do not exist in the zone Z7. The zone 8 is, for example, used as a selling space for miscellaneous goods, and the stairs STR exist in the zone Z8. The zone Z9 is, for example, used as a selling space for shoes, and the elevator EL exists in the zone Z9. The zone Z10 is, for example, used as a selling space for discounted items. The entrances 11 and 21 and the facilities for enabling the device 30 to be moved between the floors do not exist in the zone Z10, but a two-story ceiling 13 exists in the zone Z10. The zone 11 is, for example, used as a selling space for pants, and the entrances 11 and 21 and the facilities for enabling the device 30 to be moved between the floors do not exist in the zone Z11. The zone Z12 is, for example, used as a selling space for skirts, and the escalator ESC exists in the zone Z13. Each of the zones Z6 to Z12 is defined by positional coordinates indicating a specific position (for example, any of four corners) as the origin of the zone. For example, the zone Z12 is defined to be in a range of positional coordinates (18, 12) to positional coordinates (30, 20) on the second floor.

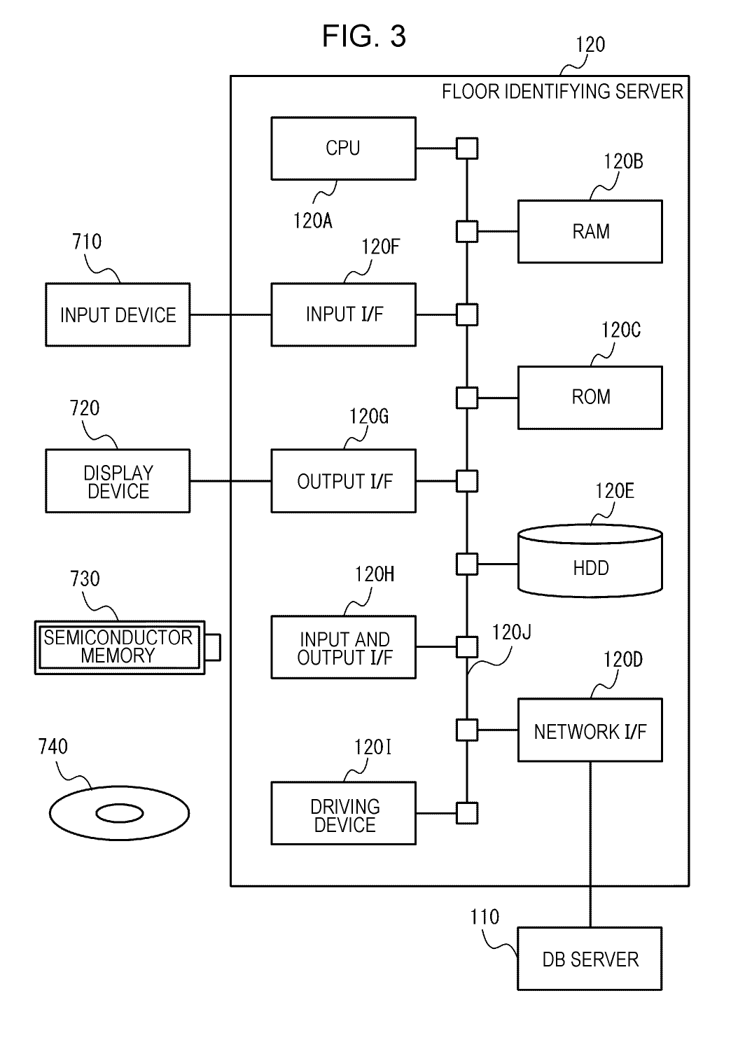

Next, a hardware configuration of the floor identifying server 120 is described with reference to FIG. 3. A hardware configuration of the aforementioned DB server 110 is basically the same as or similar to that of the floor identifying server 120, and a description thereof is omitted.

FIG. 3 illustrates an example of the hardware configuration of the floor identifying server 120. As illustrated in FIG. 3, the floor identifying server 120 includes a central processing unit (CPU) 120A, a random access memory (RAM) 120B, a read only memory (ROM) 120C, and a network interface (I/F) 120D. The floor identifying server 120 may include one or more of a hard disk drive (HDD) 120E, an input I/F 120F, an output I/F 120G, an input and output I/F 120H, and a driving device 1201. The CPU 120A, the RAM 120B, the ROM 120C, the network I/F 120D, the HDD 120E, the input I/F 120F, the output I/F 120G, the input and output I/F 120H, and the driving device 1201 may be coupled to each other via an internal bus 120J. A computer is achieved by causing the CPU 120A and the RAM 120B to collaborate with each other.

An input device 710 may be coupled to the input I/F 120F. For example, as the input device 710, a keyboard, a mouse, or the like may be used.

A display device 720 may be coupled to the output I/F 120G. For example, as the display device 720, a liquid crystal display may be used.

A semiconductor memory 730 may be coupled to the input and output I/F 120H. For example, as the semiconductor memory 730, a Universal Serial Bus (USB) memory, a flash memory, or the like may be used. The input and output I/F 120H may read a program stored in the semiconductor memory 730 and data stored in the semiconductor memory 730.

Each of the input I/F 120F and the input and output I/F 120H may include, for example, an USB port. The output I/F 120G may include, for example, a display port.

A portable recording medium 740 may be inserted in the driving device 1201. For example, as the portable recording medium 740, a removable disc such as a compact disc (CD), a ROM, or a digital versatile disc (DVD) may be used. The driving device 1201 may read a program recorded in the portable recording medium 740 and data recorded in the portable recording medium 740.

The network I/F 120D includes, for example, a LAN port. The network I/F 120D is coupled to the DB server 110.

In the aforementioned RAM 120B, programs stored in the ROM 120C and the HDD 120E are stored by the CPU 120A. In the RAM 120B, the program recorded in the portable recording medium 740 is stored by the CPU 120A. Various functions are achieved by causing the CPU 120A to execute the stored programs, and various processes described later are executed by causing the CPU 120A to execute the stored programs. The programs may correspond to flowcharts described later.

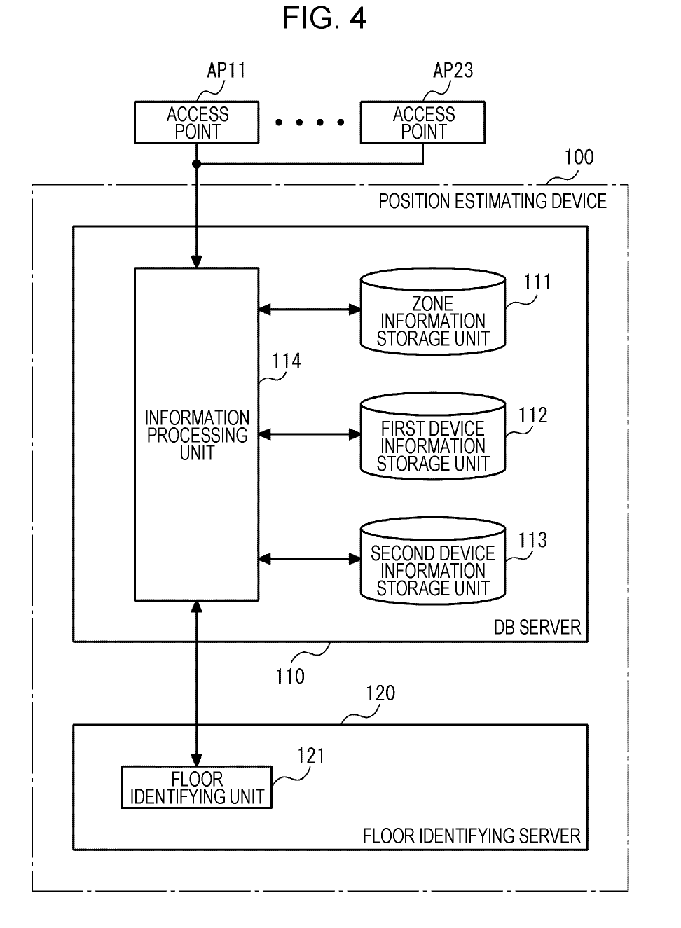

Next, functions of the DB server 110 and functions of the floor identifying server 120 are described with reference to FIGS. 4 to 7.

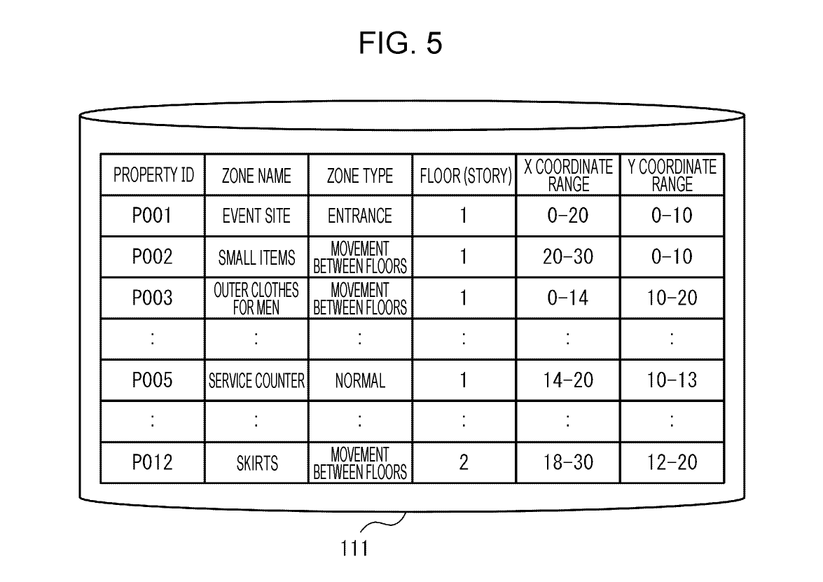

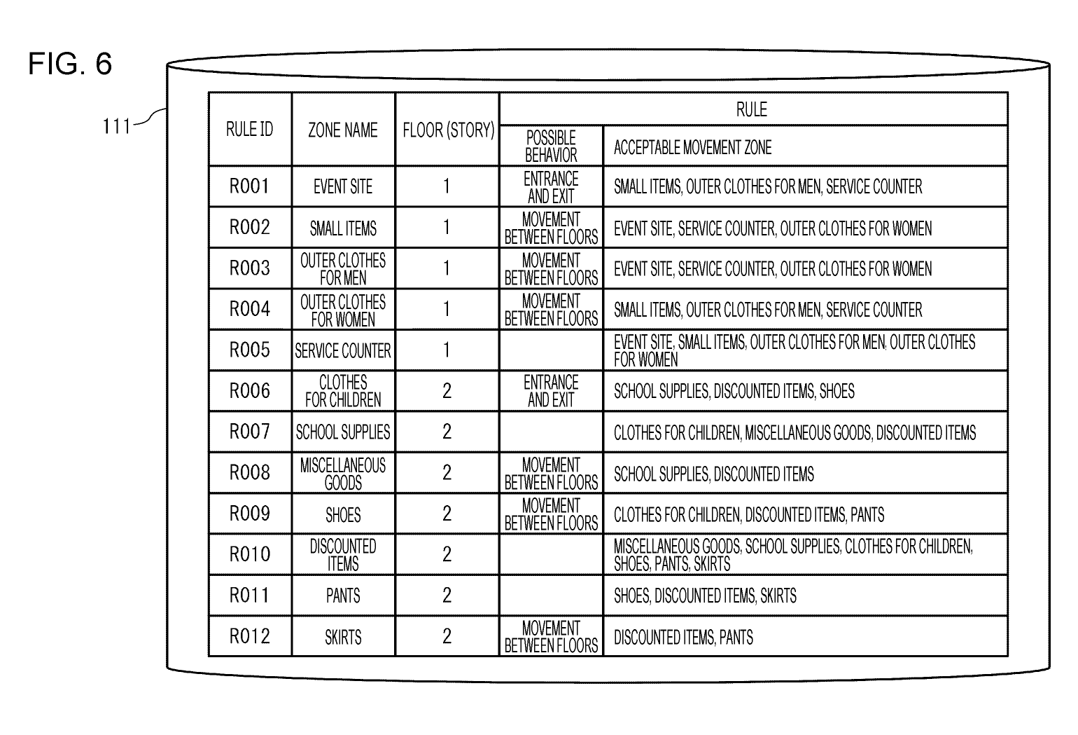

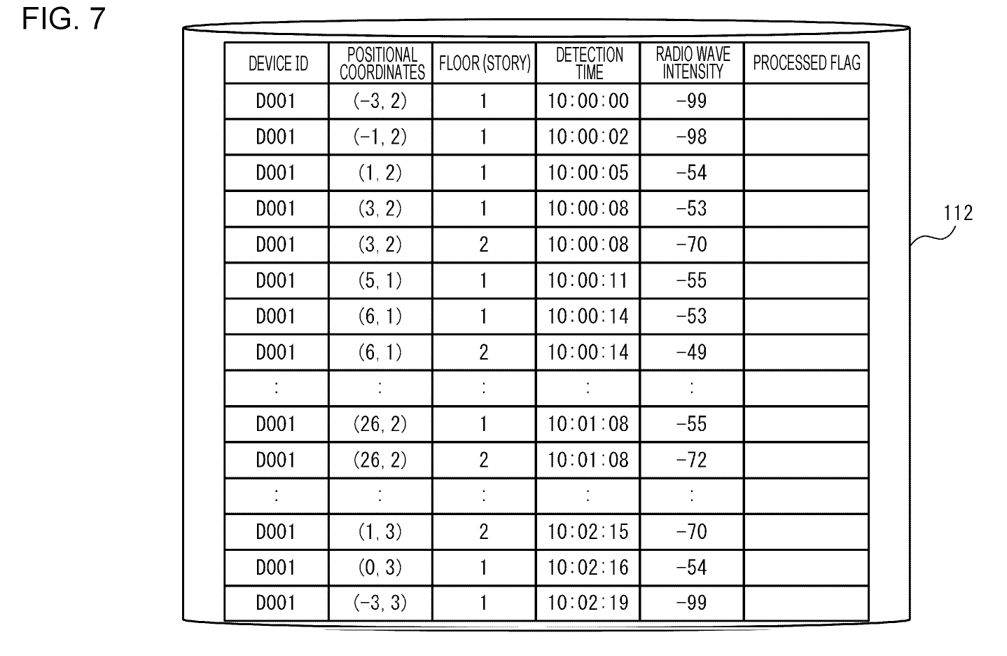

First, the functions of the DB server 110 are described below. FIG. 4 illustrates an example of a functional block diagram of the position estimating device 100. FIG. 5 illustrates an example of property information. FIG. 6 illustrates an example of rule information. FIG. 7 illustrates an example of device information. As illustrated in FIG. 4, the DB server 110 includes a zone information storage unit 111, a first device information storage unit 112, a second device information storage unit 113, and an information processing unit 114. As units for achieving the zone information storage unit 111, the first device information storage unit 112, the second device information storage unit 113, and the information processing unit 114, an on-memory or a file system may be used.

The zone information storage unit 111 stores zone information. For example, the zone information storage unit 111 stores property information and the aforementioned rule information as the zone information. The property information indicates attributes of the aforementioned zones Z1 to Z12. For example, as illustrated in FIG. 5, the property information includes, as constituent elements, property IDs, zone names, zone types, floors, X coordinate ranges, and Y coordinate ranges. The property IDs indicate identification information identifying the property information. The zone names indicate names of the zones Z1 to Z12. The zone types indicate types of the zones Z1 to Z12. For example, a zone type “entrance” indicates that the entrance 11 or the entrance 21 exists in a corresponding zone. A zone type “movement between floors” indicates that the stairs STR, the elevator EL, or the escalator ESC exist or exists in a corresponding zone. A zone type “normal” indicates that the entrances 11 and 21 and the facilities for enabling the device 30 to be moved between the floors do not exist in a corresponding zone. The floors indicate whether each of the zones Z1 to Z12 belongs to the first floor or the second floor. The X coordinate ranges and the Y coordinate ranges indicate ranges of the zones Z1 to Z12. The property information is stored in the zone information storage unit 111 in advance.

The rule information is generated by the information processing unit 114 based on the property information. For example, the information processing unit 114 acquires the property information from the zone information storage unit 111, generates the rule information based on the acquired property information, and causes the generated rule information to be stored in the zone information storage unit 111. Thus, the zone information storage unit 111 stores the rule information. The information processing unit 114 may not generate the rule information, and an administrator who manages the DB server 110 may generate the rule information and cause the rule information to be stored in the zone information storage unit 111.

As illustrated in FIG. 6, the rule information includes rule IDs, zone names, floors, and rules as constituent elements. Especially, the rules include possible behaviors and acceptable movement zones as constituent elements. The rule IDs indicate identification information identifying the rule information. The zone names and the floors are already described, and a description thereof is omitted.

The possible behaviors indicate possible behaviors in the zones Z1 to Z12. For example, the entrance 11 exists in the zone Z1 with a zone name “event site”. Thus, a possible behavior “entrance and exit” indicating that the device 30 may be placed into and out of the facility FC is registered. For example, the stairs STR exist in the zone Z2 with a zone name “small items”. Thus, a possible behavior “movement between floors” indicating that the device 30 may be moved between the floors is registered.

The acceptable movement zones indicate zone names of adjacent zones to which the device 30 is permitted to be directly moved from the zones Z1 to Z12. Since the property information includes the X coordinate ranges and the Y coordinate ranges, the information processing unit 114 may determine the acceptable movement zones. For example, the zone Z6 is adjacent to the zones Z7, Z9, and Z10 (refer to FIG. 2B). Thus, the information processing unit 114 determines, as acceptable movement zones of the zone Z6, zone names “school supplies”, “shoes”, and “discounted items” given to the zones Z7, Z9, and Z10, and registers the determined acceptable movement zones in the rule information. In other words, the zone Z6 is not adjacent to the zones Z8, Z11, and Z12. Thus, the information processing unit 114 determines zone names “miscellaneous goods”, “pants”, and “skirts” given to the zones Z8, Z11, and Z12 as unacceptable movement zones to which the device 30 is not permitted to be directly moved from the zone Z6, and the information processing unit 114 excludes the determined unacceptable movement zones from targets to be registered in the rule information.

Returning to FIG. 4, the information processing unit 114 acquires radio wave intensities, the device ID, and detection time from the access points AP11 to AP13 and AP21 to AP23. The information processing unit 114 estimates positional coordinates of the device 30 based on the acquired radio wave intensities and positional coordinates (not illustrated), registered in the DB server 110 in advance, of the access points AP11 to AP13 and AP21 to AP23. The information processing unit 114 generates device information including the device ID, the radio wave intensities, the detection time, the estimated positional coordinates, and the like and causes the generated device information to be stored in the first device information storage unit 112.

As illustrated in FIG. 7, the device information includes the device ID, the positional coordinates, the floors, the detection time, the radio wave intensities, and a processed flag as constituent elements. For example, as the device ID, a Media Access Control (MAC) address may be used. The device ID, however, is not limited to the MAC address as long as the device 30 is identified by the device ID. The positional coordinates indicate positional coordinates estimated by the information processing unit 114. Positional coordinates indicated by negative X coordinates indicate that the position of the device 30 is located outside the facility FC. The floors indicate the stories on which the access points AP11 to AP13 and AP21 to AP23 used to estimate the positional coordinates are installed. The detection time indicates time when the access points AP11 to AP13 and AP21 to AP23 have detected the device 30. The radio wave intensities indicate the intensities of radio waves detected by the access points AP11 to AP13 and AP21 to AP23. In a column for processed flags, a flag indicating whether or not a floor identification process described later has been executed is registered.

According to FIG. 7, for example, positional coordinates (6, 1) are estimated based on a radio wave intensity “−53” decibels (dBm) detected by any of the access points AP11 to AP13 on the first floor at time “10:00:14”. The same positional coordinates (6, 1) are estimated based on a radio wave intensity “−49” decibels (dBm) detected by any of the access points AP21 to AP23 on the second floor at time “10:00:14”. Since the radio wave intensity “−49” decibels is higher than the radio wave intensity “−53” decibels, the any of the access points AP21 to AP23 installed on the second floor has detected the higher radio wave intensity than that detected by the any of the access points AP11 to AP13 installed on the first floor. This is caused by structures of facilities such as the two-story ceiling 13, the ceiling, the decorative objects, and the mezzanine.

The second device information storage unit 113 stores a portion of the device information stored in the first device information storage unit 112. For example, the floor identification process described later is executed, and device information of an identified floor among the floors is stored in the second device information storage unit 113. In other words, the second device information storage unit 113 stores device information excluding device information including erroneously estimated positional coordinates from the device information stored in the first device information storage unit 112.

Returning to FIG. 4, the functions of the floor identifying server 120 are described below. As illustrated in FIG. 4, the floor identifying server 120 includes a floor identifying unit 121 as an identifying unit. The floor identifying unit 121 may be included in the DB server 110, and the floor identifying server 120 may be removed from the position estimating device 100. In this case, the position estimating device 100 is achieved by the single server device.

The floor identifying unit 121 requests the information processing unit 114 to transmit various types of information at specific time. For example, the floor identifying unit 121 monitors the information processing unit 114. When the floor identifying unit 121 detects that the information processing unit 114 has caused the device information to be stored in the first device information storage unit 112, the floor identifying unit 121 requests the information processing unit 114 to transmit the information. For example, the floor identifying unit 121 requests and acquires the property information, the rule information, and the device information. Upon acquiring the information, the floor identifying unit 121 associates the device information, the property information, and the rule information with each other, executes the floor identification process described later, and transmits results of the execution to the information processing unit 114. Detailed functions and operations of the floor identifying unit 121 are described later.

Next, operations of the DB server 110 and operations of the floor identifying server 120 are described below.

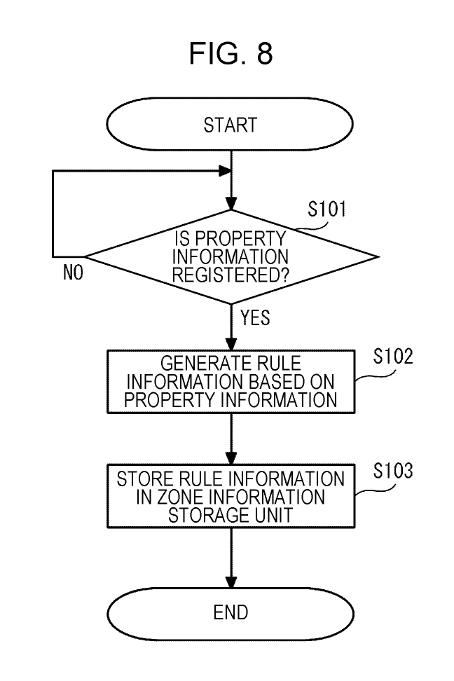

First, the operations of the DB server 110 are described with reference to FIGS. 8 to 11B. FIG. 8 is a flowchart illustrating an example of a process to be executed by the information processing unit 114. For example, FIG. 8 illustrates a process of generating the rule information. As illustrated in FIG. 8, the information processing unit 114 stands by until the property information is registered (NO in step S101). For example, the information processing unit 114 stands by until the property information is registered in the zone information storage unit 111. When the property information is registered (YES in step S101), the information processing unit 114 generates the rule information based on the property information (in step S102) and causes the generated rule information to be stored in the zone information storage unit 111 (in step S103). Thus, the zone information storage unit 111 stores the property information and the rule information as the zone information.

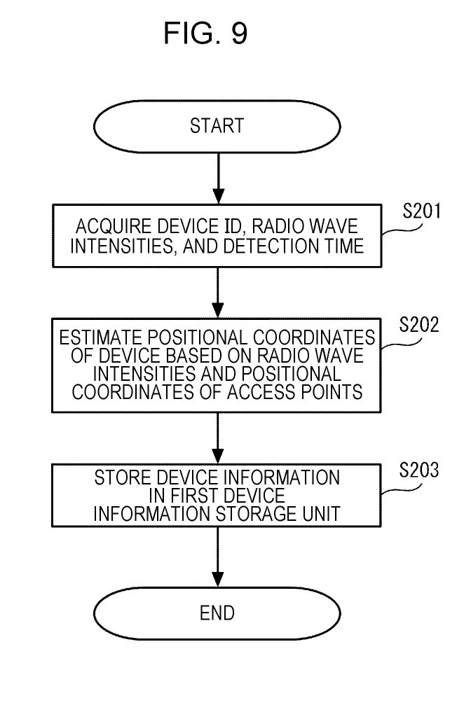

FIG. 9 is a flowchart illustrating an example of another process to be executed by the information processing unit 114. For example, FIG. 9 illustrates a process of estimating positional coordinates of the device 30. As illustrated in FIG. 9, the information processing unit 114 acquires the device ID, radio wave intensities, and detection time from the access points AP11 to AP13 and AP21 to AP23 (in step S201). After the process of step S201 is completed, the information processing unit 114 estimates positional coordinates of the device 30 based on the radio wave intensities and positional coordinates of the access points AP11 to AP13 and AP21 to AP23 (in step S202).

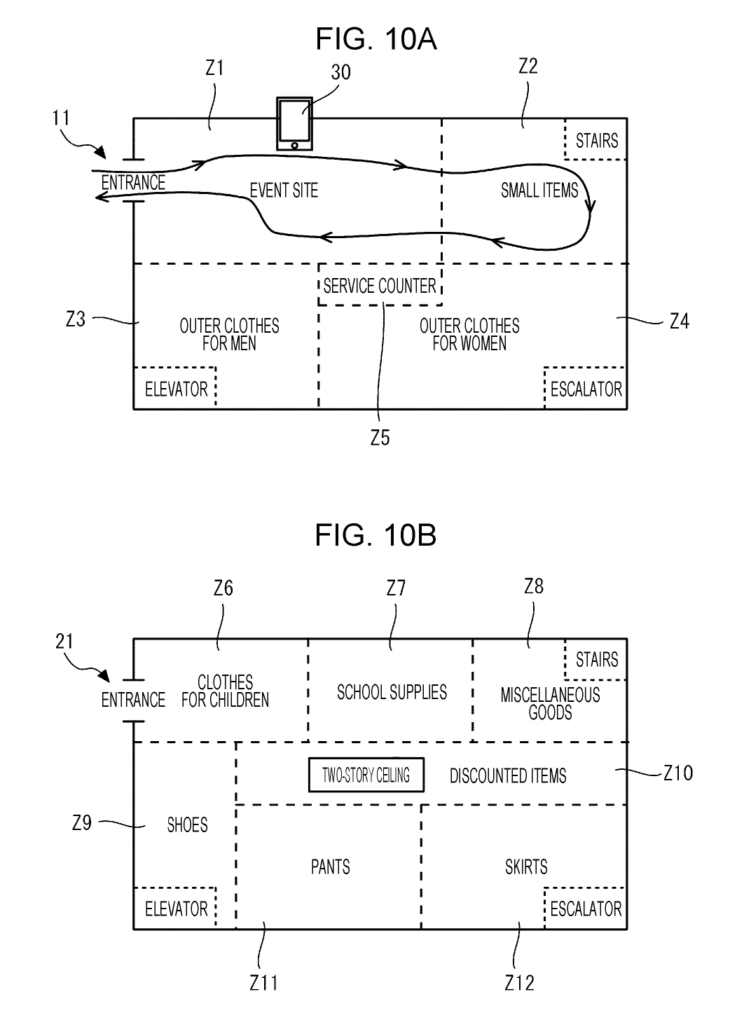

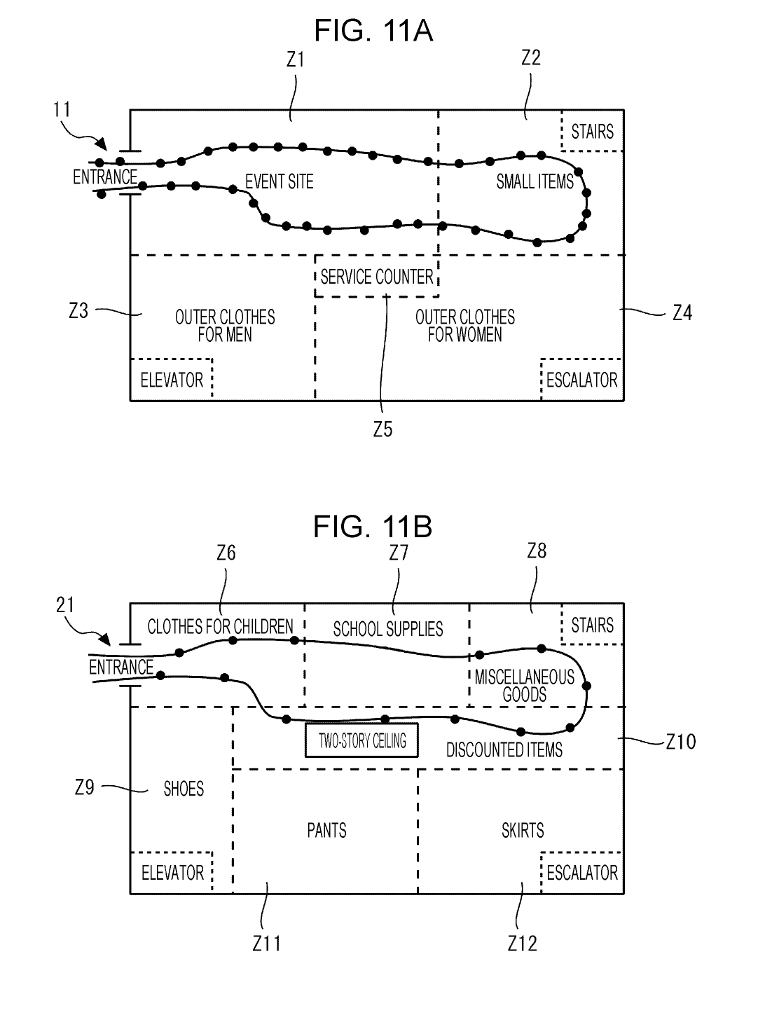

FIG. 10A illustrates an example of a movement of a device on a first floor. FIG. 10B illustrates an example of a state of a second floor on which no device exists. FIG. 11A illustrates a trajectory of positional coordinates of a device detected by access points installed on the first floor. FIG. 11B illustrates a trajectory of positional coordinates of a device detected by access points installed on the second floor. For example, as illustrated in FIG. 10A, when the device 30 held by the user USR is moved into the zone Z1 from the entrance 11 on the first floor, passes through the zone Z2, and is returned to the zone Z1 and moved out of the zone Z1 through the entrance 11, the information processing unit 114 uses radio wave intensities detected by the access points AP11 to AP13 to estimate multiple combinations of candidate positional coordinates (black points illustrated in FIG. 11A), as illustrated in FIG. 11A. A certain trajectory is obtained by connecting the estimated candidate positional coordinates in chronological order.

As illustrated in FIG. 10B, the device 30 does not exist on the second floor, but the access points AP21 to AP23 installed on the second floor communicate with the device 30 and detect radio wave intensities from the device 30. Thus, as illustrated in FIG. 11B, the information processing unit 114 uses the radio wave intensities detected by the access points AP21 to AP23 to estimate multiple combinations of candidate positional coordinates (black points illustrated in FIG. 11B), as illustrated in FIG. 11B. In the same manner as described above, a certain trajectory is obtained by connecting the estimated candidate positional coordinates in chronological order. In this manner, the device 30 actually exists on the first floor, but positional coordinates of the device 30 are estimated as if the device 30 existed on the second floor.

After the process of step S202 is completed, the information processing unit 114 causes device information to be stored in the first device information storage unit 112 (in step S203). For example, the information processing unit 114 causes the device information, which includes the device ID, the estimated positional coordinates, the stories on which the access points AP11 to AP13 and AP21 to AP23 are installed, time when the device 30 has been detected, and the radio wave intensities, to be stored in the first device information storage unit 112. Thus, the first device information storage unit 112 stores both of device information based on the radio wave intensities detected by the access points AP11 to AP13 installed on the first floor and device information based on the radio wave intensities detected by the access points AP21 to AP23 installed on the second floor.

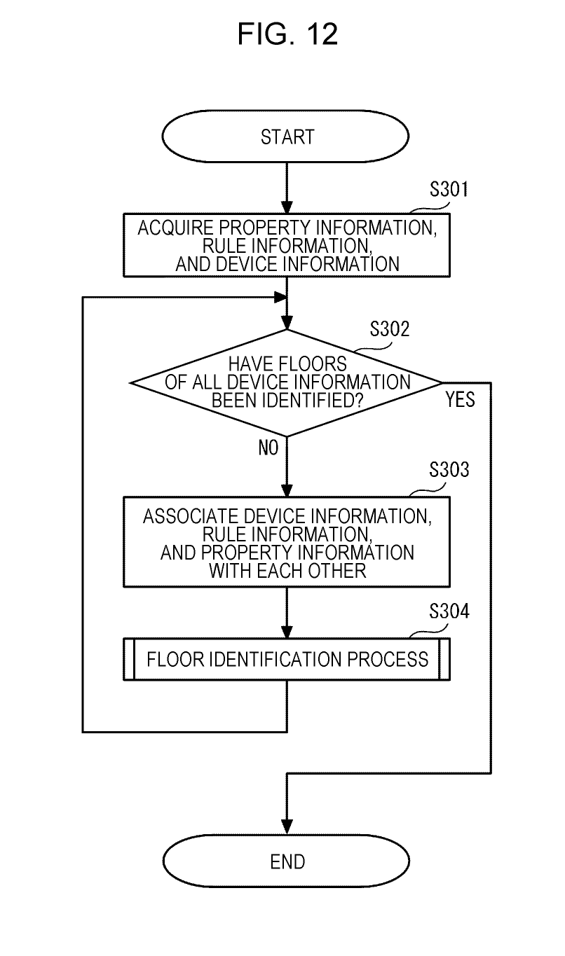

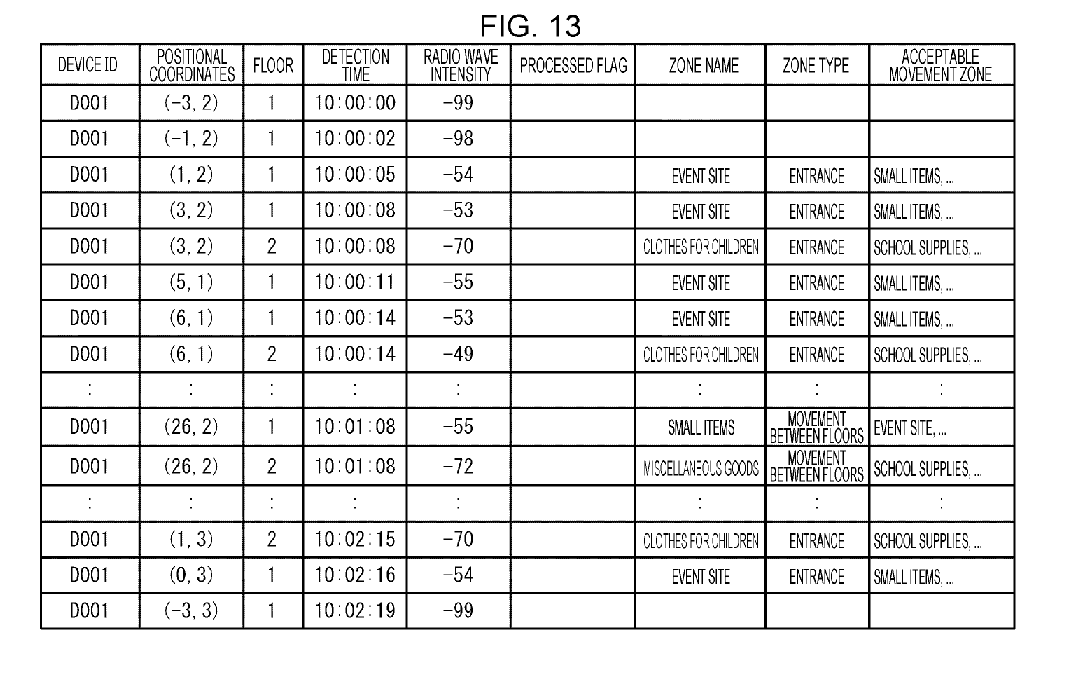

Next, the operations of the floor identifying server 120 are described with reference to FIGS. 12 and 13. FIG. 12 is a flowchart illustrating an example of the operations of the floor identifying unit 121. FIG. 13 illustrates an example of information to be analyzed. As illustrated in FIG. 12, the floor identifying unit 121 acquires the property information, the rule information, and the device information (in step S301).

For example, the floor identifying unit 121 monitors the information processing unit 114. When the information processing unit 114 causes the device information to be stored in the first device information storage unit 112, the floor identifying unit 121 transmits a request to transmit the property information, the rule information, and the device information to the information processing unit 114. Note that the floor identifying unit 121 does not transmit a request to transmit all the device information, but transmits the request to transmit device information in which a processed flag is not registered. Upon receiving the request to transmit the information from the floor identifying unit 121, the information processing unit 114 extracts the property information and the rule information from the zone information storage unit 111 and extracts the device information from the first device information storage unit 112. The information processing unit 114 transmits the extracted property information, the extracted rule information, and the extracted device information to the floor identifying unit 121.

After the process of step S301 is completed, the floor identifying unit 121 determines whether or not the floors of all the acquired device information have been identified (in step S302). For example, the floor identifying unit 121 determines whether or not the floors of all the device information in which a processed flag is not registered have been identified. When the floors of all the device information have not been identified (NO in step S302), the floor identifying unit 121 associates the device information, the rule information, and the property information with each other (in step S303). For example, the flow identifying unit 121 associates the device information, the rule information, and the property information with each other by determining whether or not each combination of positional coordinates included in the device information belong to any of the zones Z1 to Z12 identified by the X and Y coordinate ranges indicated in the property information.

Thus, as illustrated in FIG. 13, information, which is to be analyzed and in which the device information is associated with the rule information and the property information that serve as the zone information, is generated. After the process of step S303 is completed, the floor identifying unit 121 executes the floor identification process (in step S304). After the process of step S304 is completed, the floor identifying unit 121 executes the process of step S302 again. When the floors of all the device information have been identified (YES in step S302), the process is terminated.

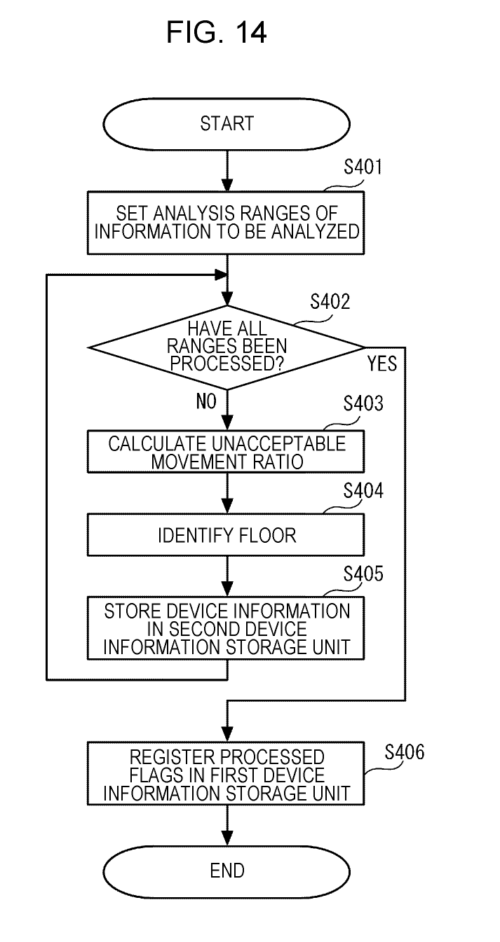

Next, the floor identification process is described with reference to FIGS. 14 to 17B.

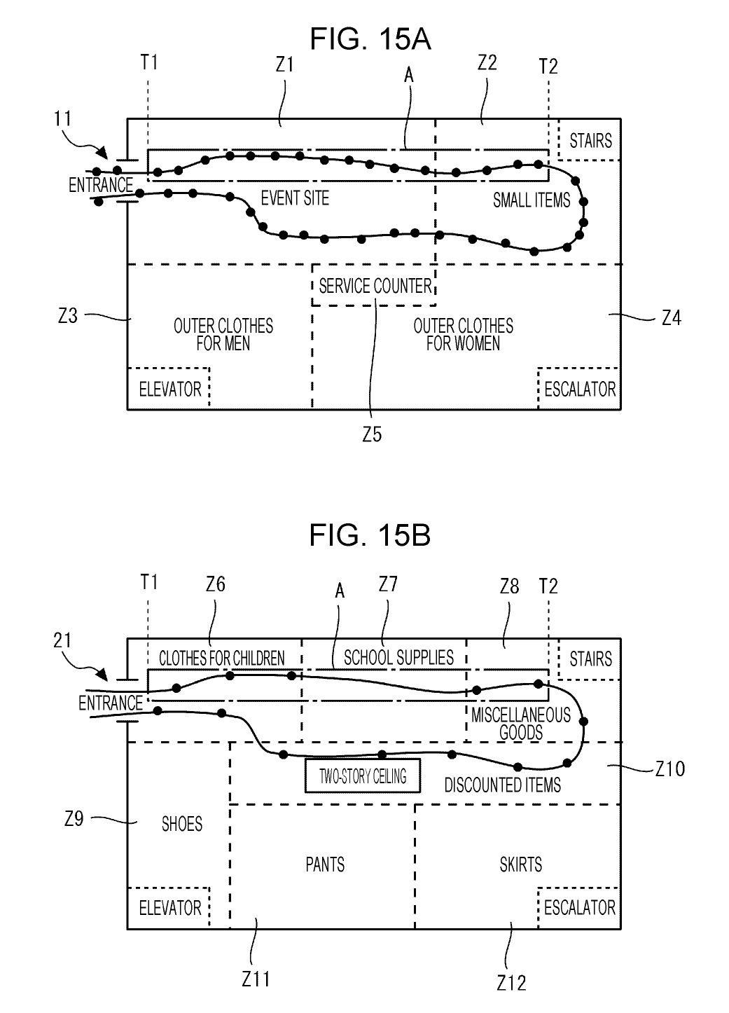

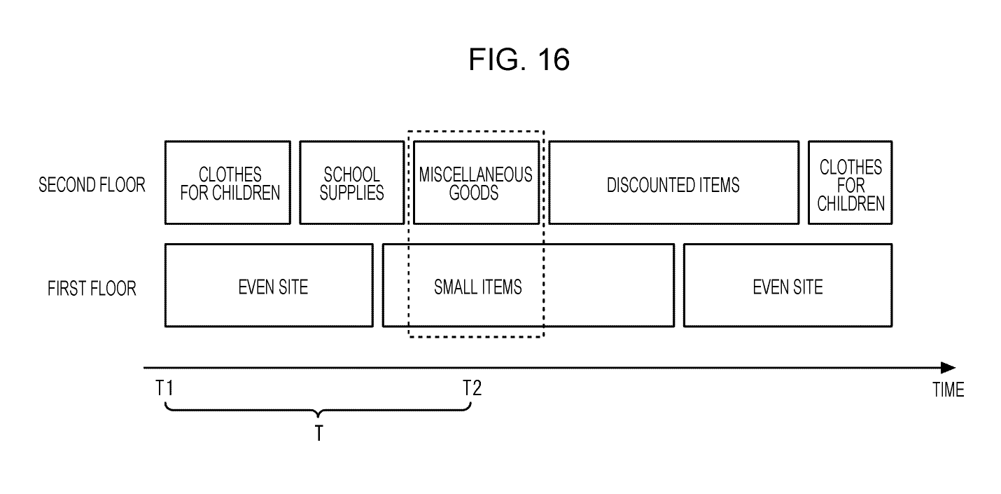

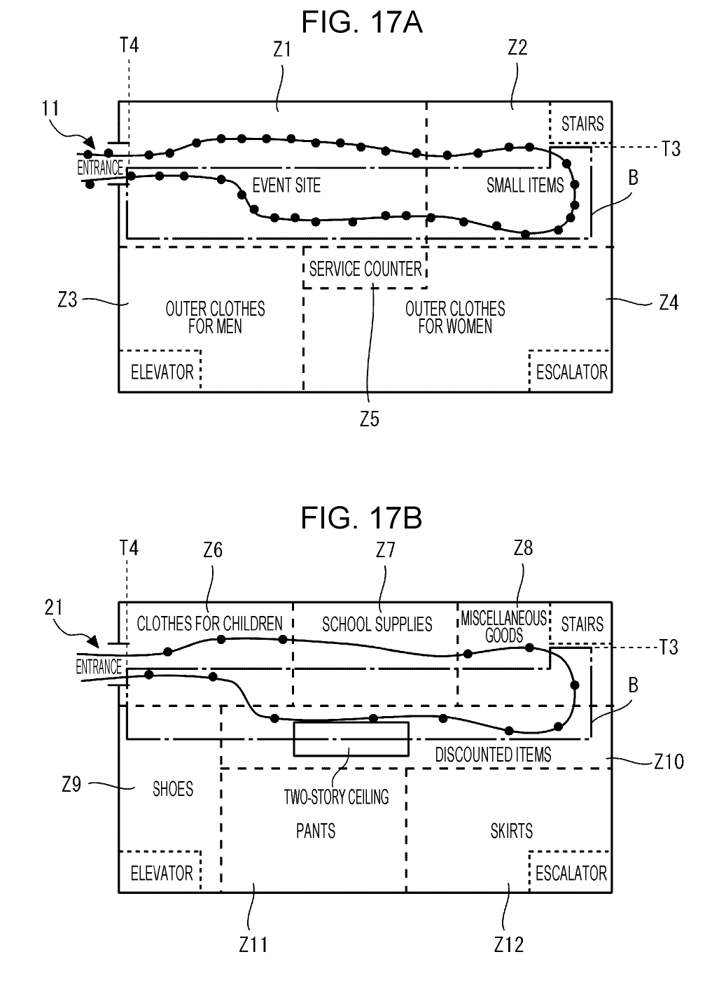

FIG. 14 is a flowchart illustrating an example of the floor identification process. FIGS. 15A and 15B are diagrams describing an example of an analysis range A, where FIG. 15A illustrates the analysis range A for the first floor and FIG. 15B illustrates the analysis range for the second floor. FIG. 16 is a diagram describing an example of time when the device is moved between the floors. FIGS. 17A and 17B are diagrams describing an example of an analysis range B.

First, as illustrated in FIG. 14, the floor identifying unit 121 sets analysis ranges of the information to be analyzed (in step S401). As an example, as illustrated in FIG. 15A, the floor identifying unit 121 sets, as the analysis range A for the first floor, a time period from time T1 when the device 30 has started to exist in the zone Z1 in which the entrance 11 exists to time T2 when the device 30 has existed in the zone Z2 from which the device 30 may be moved between the floors. As illustrated in FIG. 15B, the analysis range A is also applied to the second floor. Thus, a portion of a trajectory of the device 30 exists in the zones Z2 and Z8. For example, as illustrated in FIG. 16, the device 30 may be moved between the floors or between the zone Z2 used as the selling space for small items and the zone Z8 used as the selling space for miscellaneous goods.

The reason why the analysis range A is set in the aforementioned manner is that when the device 30 is moved between the floors, time when the device 30 is detected tends to change. For example, as illustrated in FIG. 15A, when the device 30 is moved to the second floor from the zone Z2 in a state in which the device 30 existing on the first floor is detected at predetermined time intervals, time intervals at which the device 30 is detected during a time period during which the device 30 is returned from the zone Z2 to the zone Z1 may be increased, compared with time intervals at which the device 30 existing on the first floor before being moved to the second floor is detected. On the other hand, time intervals at which the device 30 is detected during a time period during which the device 30 is moved from the zone Z8 through the zone Z10 to the zone Z6 on the second floor may be reduced. Thus, the floor identifying unit 121 sets the analysis range and identifies a floor on which the device 30 exists by using positional coordinates of the first floor at which time intervals of the device 30 being detected does not tend to change, and positional coordinates of the second floor at which time intervals of the device 30 being detected does not tend to change.

FIGS. 17A and 17B are diagrams describing an example of an analysis range B, where FIG. 17A indicates the analysis range B for the first floor and FIG. 17B indicates the analysis range B for the second floor. As another example, as illustrated in FIG. 17A, the floor identifying unit 121 may set, as the analysis range B for the first floor, a time period from time T3 when the device 30 has existed in the zone Z2 from which the device 30 may be moved between the floors, to time T4 when the device 30 has been stopped existing in the zone Z1 in which the entrance 11 exists. As illustrated in FIG. 17B, the analysis range B is also applied to the second floor. The first embodiment is described using the analysis range A and the analysis range B.

A time period from the time T1 when the device 30 has started to exist in the zone Z1 in which the entrance 11 exists, to the time T4 when the device 30 has been stopped existing in the zone Z1 in which the entrance 11 exists, may be set as a single analysis range. In addition, a time period from time when the device 30 starts to exist in any of the zones that are included in the zones Z1 to Z12 and from which the device 30 may be moved between the floors, to time when the device 30 starts to exist in another one of the zones that are included in the zones Z1 to Z12 and from which the device 30 may be moved between the floors, may be set as a single analysis range. The analysis ranges may be manually set by the administrator.

After the process of step S401 is completed, the floor identifying unit 121 determines whether or not all the ranges have been processed (in step S402). In the first embodiment, the floor identifying unit 121 determines whether or not the analysis ranges A and B have been completely processed. When all the ranges have not been completely processed (NO in step S402), the floor identifying unit 121 calculates unacceptable movement ratios (in step S403). Each of the unacceptable movement ratios is a ratio of the number of times the device 30 has been moved to a zone to which the device 30 is not permitted to be directly moved, to the total number of combinations of positional coordinates belonging to the analysis range A or the analysis range B. Although the analysis range A is described as a target to be processed as an example, the same applies to the analysis range B.

First, the floor identifying unit 121 uses acceptable movement zones indicated in the information, which is to be analyzed, to calculate an unacceptable movement ratio for each of the floors. The calculation is described in detail with reference to FIG. 15A. The total number of combinations of positional coordinates belonging to the analysis range A of the first floor is 16. Based on the acceptable movement zones (refer to FIGS. 6 and 13) indicated in the information to be analyzed, information indicating that the zone Z1 with the zone name “event site” and the zone Z2 with the zone name “small items” are acceptable movement zones is registered. Thus, the number of times that the device 30 has been moved to a zone to which the device 30 is not permitted to be directly moved is 0. Thus, an unacceptable movement ratio for the first floor is calculated to be 0=0 (times)/16 (combinations of positional coordinates).

On the other hand, as illustrated in FIG. 15B, the total number of combinations of positional coordinates belonging to the analysis range A of the second floor is 5. Based on the acceptable movement zones (refer to FIGS. 6 and 13) indicated in the information to be analyzed, information indicating that the zone Z6 with the zone name “clothes for children” and the zone Z8 with the zone name “miscellaneous goods” are acceptable movement zones is not registered. Therefore, when the device 30 moves from the zone Z6 to the zone Z8, the device 30 is requested to pass through the zone Z7. However, based on the positional coordinates belonging to the analysis range A of the second floor, the device 30 has been moved from the zone 6 directly to the zone Z8. Thus, the number of times that the device 30 has been moved to a zone to which the device 30 is not permitted to be directly moved is 1. Thus, an unacceptable movement ratio for the second floor is calculated to be 0.2=1 (time)/5 (combinations of positional coordinates).

Returning to FIG. 14, after the process of step S403 is completed, the floor identifying unit 121 identifies a floor (in step S404). For example, the floor identifying unit 121 identifies, as the floor on which the device 30 has existed, a floor for which a smaller unacceptable movement ratio has been calculated. In the first embodiment, the unacceptable movement ratio for the first floor is calculated to be 0, the unacceptable movement ratio for the second floor is calculated to be 0.2, and the unacceptable movement ratio for the first floor is smaller than the unacceptable movement ratio for the second floor. Thus, the floor identifying unit 121 identifies, as the floor on which the device 30 has existed, the first floor for which the smaller unacceptable movement ratio has been calculated. When the unacceptable movement ratio for the first floor is equal to the unacceptable movement ratio for the second floor, the floor identifying unit 121 identifies, as the floor on which the device 30 has existed, a floor on which the device 30 has been detected a larger number of times.

After the process of step S404 is completed, the floor identifying unit 121 causes device information to be stored in the second device information storage unit 113 (in step S405). For example, the floor identifying unit 121 deletes device information in which the second floor has been registered in a column for floors, from pieces of device information corresponding to information that is to be analyzed and has been set for the analysis range A, and the floor identifying unit 121 causes the remaining device information to be stored in the second device information storage unit 113. The device information may be physically deleted or logically deleted using a flag or the like. Thus, the second device information storage unit 113 stores the device information in which the first floor has been registered in the column for floors for the analysis range A. The floor identifying unit 121 may causes the device information to be stored directly in the second device information storage unit 113. Alternatively, the floor identifying unit 121 may transmit the device information to the information processing unit 114, and the information processing unit 114 may cause the device information to be stored in the second device information storage unit 113.

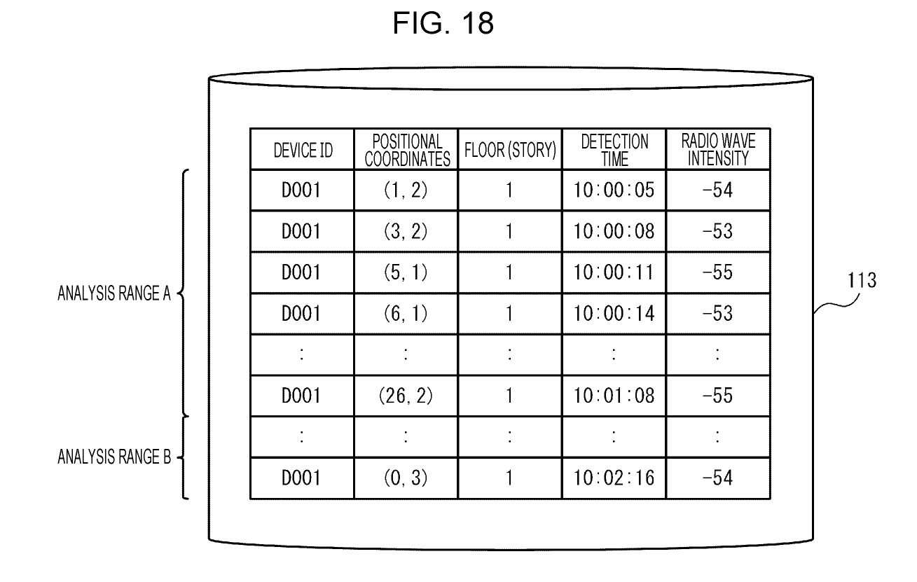

After the process of step S405 is completed, the floor identifying unit 121 executes the process of step S402. Then, the floor identifying unit 121 executes the processes of steps S403 to S405 on the analysis range B. As a result, as illustrated in FIG. 18, the second device information storage unit 113 stores device information in which the first floor has been registered in a column for floors for the analysis ranges A and B.

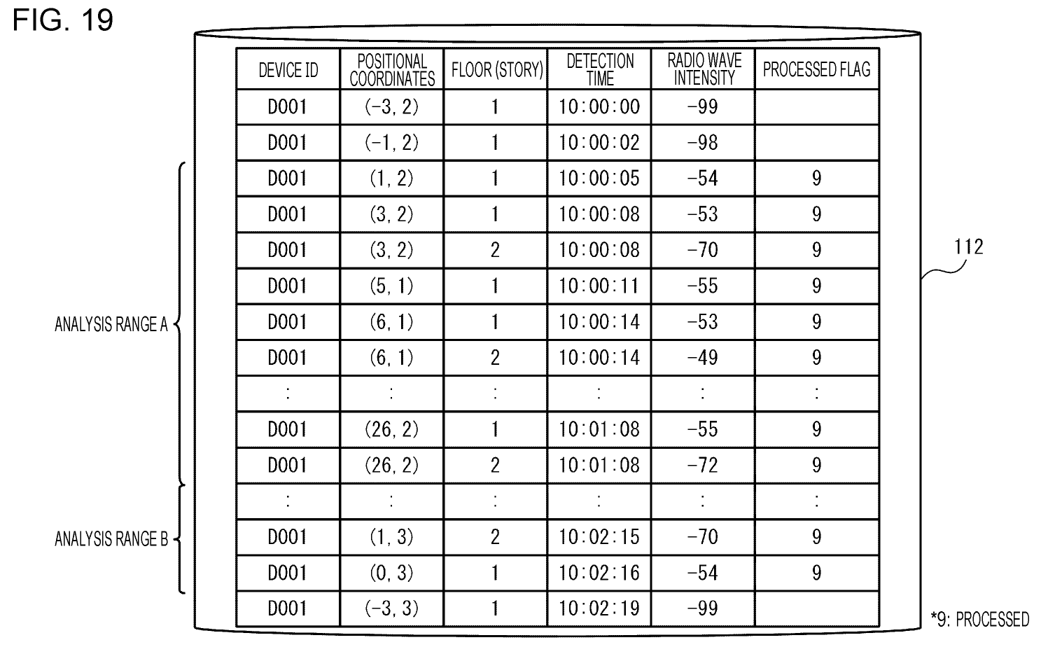

Then, when all the ranges have been processed (YES in step S402), the floor identifying unit 121 registers processed flags in the first device information storage unit 112 (in step S406). Thus, as illustrated in FIG. 19, flags “9” indicating that the process has been executed are registered in a column for processed flags in the device information corresponding to the analysis ranges A and B.

According to the first embodiment, the position estimating device 100 estimates the position of the device 30, based on the positions of the multiple access points AP11 to AP13 and AP21 to AP23 installed on the multiple floors, and intensities, detected by the access points AP11 to AP13 and AP21 to AP23, of radio waves transmitted by the device 30 at time points. Especially, the position estimating device 100 includes the floor identifying unit 121 for identifying a floor on which the device 30 exists. The floor identifying unit 121 generates candidate groups each indicating positions at which the device 30 may have existed on one of the multiple floors, from positional coordinates of the device 30 which are estimated at multiple time points, and identifies a floor on which the device 30 actually exists, based on the rule information and trajectories indicated by the candidate groups for the floors. Thus, the position estimating device 100 may accurately estimate the position of the device 30 and a floor on which the device 30 exists.

### Second Embodiment

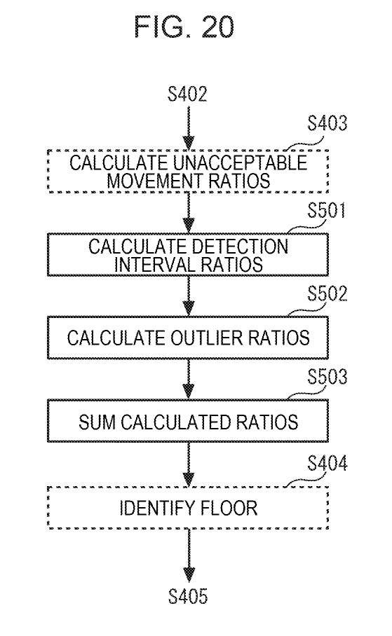

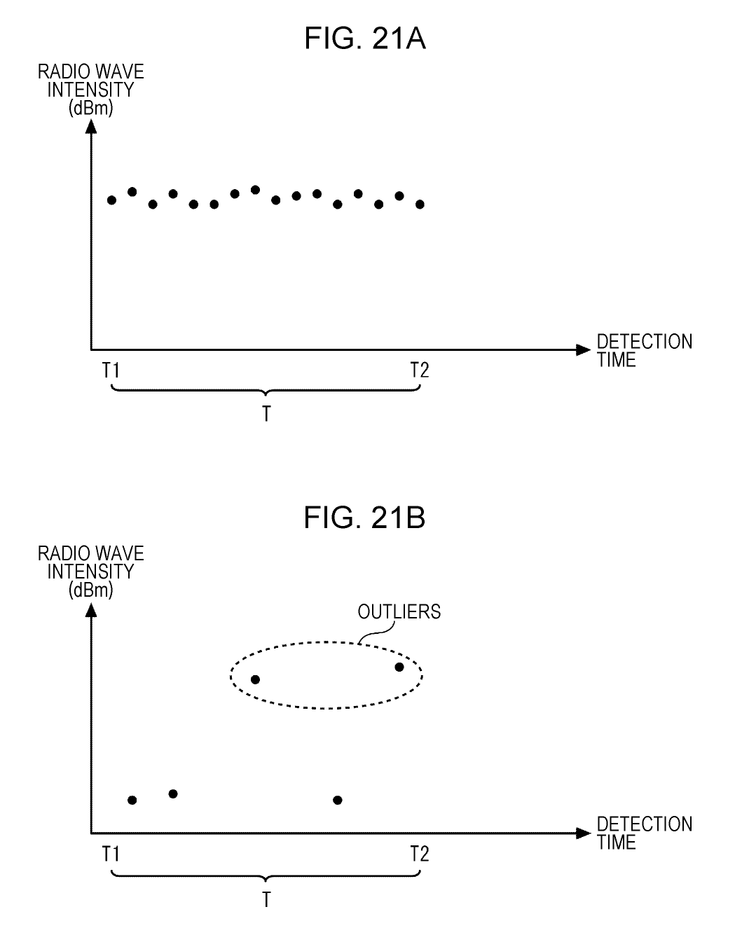

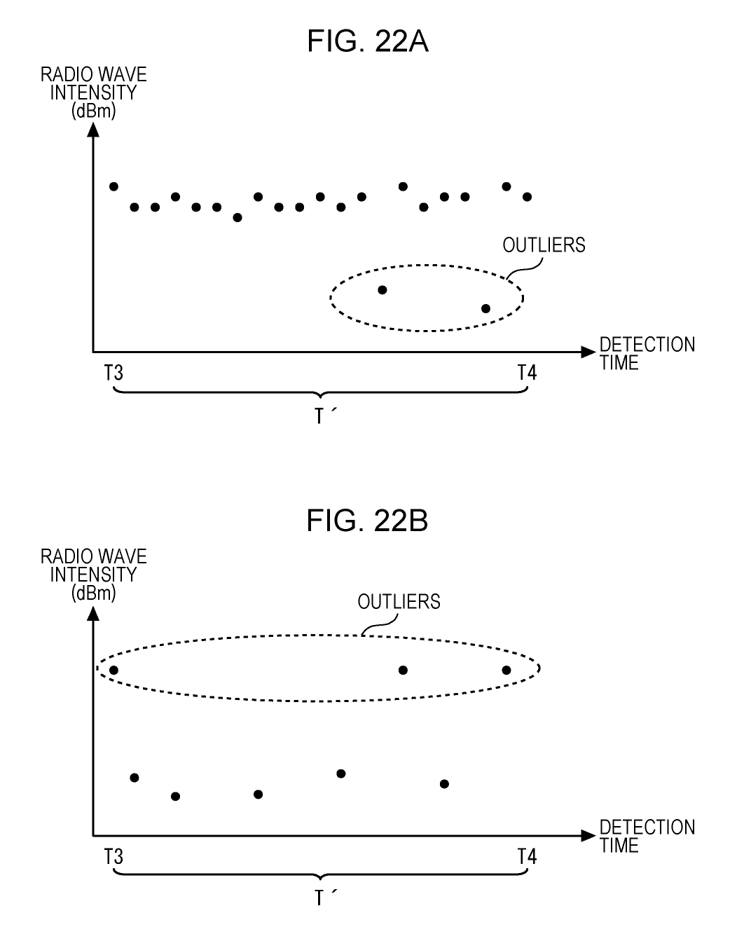

Next, a second embodiment of the disclosure is described with reference to FIGS. 20 to 22B. FIG. 20 is a flowchart exemplifying a part of the floor identification process. FIG. 21A illustrates an example of scatter diagrams indicating relationships between detection times and radio wave intensities in the analysis range A for the first floor, and FIG. 21B illustrates an example of scatter diagrams indicating relationships between detection times and radio wave intensities in the analysis range A for the second floor. FIG. 22A illustrates an example of scatter diagrams indicating relationships between detection times and radio wave intensities in the analysis range B for the first floor, and FIG. 22B illustrates an example of scatter diagrams indicating relationships between detection times and radio wave intensities in the analysis range B for the second floor. As illustrated in FIG. 20, the floor identifying unit 121 may execute processes of steps S501 to S503 (described later) between steps S403 and S404 described in the first embodiment.

For example, as illustrated in FIG. 20, after the process of step S403 is completed, the floor identifying unit 121 calculates a detection interval ratio (in step S501). The detection interval ratio is a ratio of a mean value of time intervals at which the device 30 belonging to the analysis range A of a corresponding floor is detected, to a time period during which the device 30 is moved in the analysis range A. The same applies to the analysis range B.

For example, the floor identifying unit 121 calculates, for each of the multiple floors FL1 and FL2, the ratio of a mean value of time intervals at which the device 30 is detected, to a time period from time when the device 30 has started to exist in the analysis range A to time when the device 30 has been stopped existing in the analysis range A immediately before being placed out of the analysis range A. Referring to FIG. 21A, the floor identifying unit 121 calculates a time period T from time T1 when the device 30 has started to exist in the analysis range A to time T2 when the device 30 has been stopped existing in the analysis range A immediately before being placed out of the analysis range A. Next, the floor identifying unit 121 calculates a mean value t_mean1 of time intervals between multiple points illustrated in FIG. 21A. After the floor identifying unit 121 calculates the time period T and the mean value t_mean1, the floor identifying unit 121 divides the mean value t_mean1 by the time period T to calculate a detection interval ratio t_mean1/T. In the same manner, the floor identifying unit 121 calculates a detection interval ratio t_mean2/T based on multiple points illustrated in FIG. 21B.

After the process of step S501 is completed, the floor identifying unit 121 calculates an outlier ratio (in step S502). The outlier ratio indicates a ratio of the number of outliers of radio wave intensities to the total number of times the device 30 has been detected in the analysis range A. The same applies to the analysis range B. For example, as an outlier, an outlier for which an absolute value of the difference from the mean value is K times an error, an outlier obtained using Thompson test, or the like may be used.

For example, the floor identifying unit 121 calculates, for each of the floors, a ratio of the number of outliers of radio wave intensities to the total number of times the device 30 belonging to the analysis range A has been detected. Referring to FIG. 21A, the floor identifying unit 121 counts the total number of times the device 30 belonging to the analysis range A has been detected. In the case, the number is counted as 16. Next, the floor identifying unit 121 counts the number of outliers from among the multiple black points illustrated in FIG. 21A. In the second embodiment, the number is counted as 0. After the floor identifying unit 121 counts the total number of times the device 30 has been detected and the number of outliers, the floor identifying unit 121 divides 0 by 16 to calculate an outlier ratio of 0. In the same manner, the floor identifying unit 121 calculates an outlier ratio based on the multiple black points illustrated in FIG. 21B. In the case, the total number of times the device 30 has been detected is counted as 5, the number of outliers is counted as 2, and thus the floor identifying unit 121 divides 2 by 5 to calculate an outlier ratio of 0.4.

After the process of step S502 is completed, the floor identifying unit 121 sums the calculated ratios (in step S503). Foe example, the floor identifying unit 121 sums the unacceptable movement ratio, the detection interval ratio, and the outlier ratio for each of the floors. As a result, since the unacceptable movement ratio for the first floor is 0, the detection interval ratio for the first floor is t_mean1, and the outlier ratio for the first floor is 0, the total of the ratios for the first floor is t_mean1. Since the unacceptable movement ratio for the second floor is 0.2, the detection interval ratio for the second floor is t_mean2, and the outlier ratio for the second floor is 0.4, the total of the ratios for the second floor is 0.6+t_mean2.

After the process of step S503 is completed, the floor identifying unit 121 executes the process of step S404. In the second embodiment, the floor identifying unit 121 identifies, as a floor on which the device 30 has existed, a floor for which the total of calculated ratios is smaller. In the second embodiment, as described above, the total of the ratios for the first floor is calculated to be t_mean1, and the total of the ratios for the second floor is calculated to be 0.6+t_mean2. Thus, when the total of the ratios for the first floor is smaller than the total of the ratios for the second floor, the floor identifying unit 121 identifies the first floor as the floor on which the device 30 has existed.

The floor identifying unit 121 also executes the processes of steps S501 to S503 on the analysis range B. For example, when the scatter diagrams illustrated in FIGS. 22A and 22B are obtained for the analysis range B, the floor identifying unit 121 executes the process of step S501 to calculate a time period T′ from time T3 when the device 30 has existed in the analysis range B immediately after being placed into the analysis range B to time T4 when the device 30 has stopped existing in the analysis range B. Next, the floor identifying unit 121 calculates a mean value t_mean3 of time intervals between multiple black points illustrated in FIG. 22A. After the floor identifying unit 121 calculates the time period T′ and the mean value t_mean3, the floor identifying unit 121 divides the mean value t_mean3 by the time period T′ to calculate a detection interval ratio t_mean3/T′. In the same manner, the floor identifying unit 121 calculates a detection interval ratio t_mean4/T′ based on multiple black points illustrated in FIG. 22B.

In the process of step S502, the floor identifying unit 121 counts the total number of times the device 30 belonging to the analysis range B has been detected. In the second embodiment, in the case indicated by the scatter diagram in FIG. 22A, the number is counted as 21. Next, the floor identifying unit 121 counts the number of outliers from among the multiple points illustrated in FIG. 22A. In the second embodiment, the number is counted as 2. After the floor identifying unit 121 counts the total number of times the device 30 has been detected and the number of outliers, the floor identifying unit 121 divides 2 by 21 to calculate an outlier ratio of 0.095 (the fourth and later digits after the decimal point are rounded down). In the same manner, the floor identifying unit 121 calculates an outlier ratio based on the multiple points illustrated in FIG. 22B. In this case, since the total number of times that the device 30 has been detected is counted as 8, and the number of outliers is counted as 3, the floor identifying unit 121 divides 3 by 8 to calculate an outlier ratio of 0.375 (the fourth and later digits after the decimal point are rounded down).

According to the second embodiment, the floor identifying unit 121 uses not only the unacceptable movement ratios but also the detection interval ratios and the outlier ratios to identify a floor on which the device 30 has existed. Thus, the position of the device 30 and a floor on which the device 30 has existed may be more accurately estimated, compared with the first embodiment.

Although the preferred embodiments are described above in detail, the disclosure is not limited to the specific embodiments, and the embodiments may be variously modified and changed within the gist of the disclosure. For example, although the first and second embodiments describe the facility FC having the first and second stories as the first and second floors FL1 and FL2, the facility FC may include three or more stories.

In addition, although the unacceptable movement ratio, the detection interval ratio, and the outlier ratio are summed and a floor on which the device has been detected is identified in the second embodiment, the detection interval ratios or the outlier ratios may be independently used to identify a floor on which the device has been detected. Alternatively, the unacceptable movement ratio and either the detection interval ratio or the outlier ratio may be summed to identify a floor on which the device has been detected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
determining a plurality of candidate position groups each indicating a trajectory of estimated terminal positions on a candidate floor selected from among multiple floors, wherein the trajectory of estimated terminal positions on the candidate floor is estimated based on positions of base stations installed on the candidate floor and intensities of radio waves that have been transmitted by a terminal at time points and detected by the base stations; and
identifying, from among the candidate floors selected from the multiple floors, a target floor on which the terminal actually exists, based on the trajectories of estimated terminal positions for the determined plurality of candidate position groups and a movement requirement that defines a condition of actual movement of the terminal on each of the candidate floors.

2. The non-transitory, computer-readable recording medium of claim 1, wherein
the identifying the target floor is performed based on a set of candidate position groups included in the plurality of candidate position groups, the set of candidate position groups each indicating a trajectory of estimated terminal positions whose end terminal position is located at a range in which the terminal is allowed to move between the candidate floors.

3. The non-transitory, computer-readable recording medium of claim 1, wherein
the identifying the target floor includes:
calculating, based on the movement requirement, for each of the candidate floors and each of analysis ranges that are common to the candidate floors, a first ratio indicating a ratio of a number of times the terminal has been moved into an area into which the terminal is not allowed to be moved, to a total number of estimated terminal positions of the candidate position group determined for the candidate floor, and
identifying, for each of the analysis ranges, one of the candidate floors for which the smallest first ratio has been calculated, as the target floor.

4. The non-transitory, computer-readable recording medium of claim 1, wherein
the identifying the target floor includes:
calculating, for each of the candidate floors and each of analysis ranges that are common to the candidate floors, a second ratio indicating a ratio of a mean value of time intervals at which the terminal has been detected, to a time period from time when the terminal has started to exist on the candidate floor to time when the terminal has been stopped existing on the candidate floor, and
identifying, for each of the analysis ranges, one of the candidate floors for which the smallest second ratio has been calculated, as the target floor.

5. The non-transitory, computer-readable recording medium of claim 1, wherein
the identifying the target floor includes:
calculating, for each of the candidate floors and each of analysis ranges that are common to the candidate floors, a third ratio indicating a ratio of a number of outliers of the radio wave intensities to a total number of estimated terminal positions of the candidate position group determined for the candidate floor, and
identifying, for each of the analysis ranges, one of the candidate floors for which the smallest third ratio has been calculated, as the target floor.

6. The non-transitory, computer-readable recording medium of claim 1, wherein
the identifying the target floor includes:
for each of the candidate floors and each of analysis ranges that are common to the candidate floors, calculating:
a first ratio indicating a ratio of a number of times the terminal has been moved into an area into which the terminal is not allowed to be moved, to a total number of estimated terminal positions of the candidate position group determined for the candidate floor, based on the movement requirement,
a second ratio indicating a ratio of a mean value of time intervals at which the terminal has been detected, to a time period from time when the terminal has started to exist on the candidate floor to time when the terminal has been stopped existing on the candidate floor, and
a third ratio indicating a ratio of a number of outliers of the radio wave intensities to a total number of estimated terminal positions of the candidate position group determined for the candidate floor;
obtaining a value by summing, for each of the candidate floors and each of the analysis ranges, the first ratio, the second ratio, and the third ratio; and
identifying, for each of the analysis ranges, one of the candidate floors for which the smallest value is obtained by summing the first to third ratios, as the target floor.

7. A method comprising:
determining a plurality of candidate position groups each indicating an trajectory of estimated terminal positions on a candidate floor selected from among multiple floors, wherein the trajectory of estimated terminal positions on the candidate floor is estimated based on positions of base stations installed on the candidate floor and intensities of radio waves that have been transmitted by a terminal at time points and detected by the base stations; and
identifying, from among the candidate floors selected from the multiple floors, a target floor on which the terminal actually exists, based on the trajectories of estimated terminal positions for the determined plurality of candidate position groups and a movement requirement that defines a condition of actual movement of the terminal on each of the candidate floors.

8. An apparatus comprising:
a memory; and
a processor coupled to the memory and configured to:
determine a plurality of candidate position groups each indicating an trajectory of estimated terminal positions on a candidate floor selected from among multiple floors, wherein the trajectory of estimated terminal positions on the candidate floor is estimated based on positions of base stations installed on the candidate floor and intensities of radio waves that have been transmitted by a terminal at time points and detected by the base stations, and
identify, from among the candidate floors selected from the multiple floors, a target floor on which the terminal actually exists, based on the trajectories of estimated terminal positions for the determined plurality of candidate position groups and a movement requirement that defines a condition of actual movement of the terminal on each of the candidate floors.

9. The apparatus of claim 8, wherein
the processor is configured to identify the target floor, based on a set of candidate position groups included in the plurality of candidate position groups, the set of candidate position groups each indicating a trajectory of estimated terminal positions whose end terminal position is located at a range in which the terminal is allowed to move between the candidate floors.

10. The apparatus of claim 8, wherein
the processor is configured to:
calculate, based on the movement requirement, for each of the candidate floors and each of analysis ranges that are common to the candidate floors, a first ratio indicating a ratio of a number of times the terminal has been moved into an area into which the terminal is not allowed to be moved, to a total number of estimated terminal positions of the candidate position group determined for the candidate floor, and
identify, for each of the analysis ranges, one of the candidate floors for which the smallest first ratio has been calculated, as the target floor.

11. The apparatus of claim 8, wherein
the processor is configured to:
calculate, for each of the candidate floors and each of analysis ranges that are common to the candidate floors, a second ratio indicating a ratio of a mean value of time intervals at which the terminal has been detected, to a time period from time when the terminal has started to exist on the candidate floor to time when the terminal has been stopped existing on the candidate floor, and
identify, for each of the analysis ranges, one of the candidate floors for which the smallest second ratio has been calculated, as the target floor.

12. The apparatus of claim 8, wherein
the processor is configured to:
calculate, for each of the candidate floors and each of analysis ranges that are common to the candidate floors, a third ratio indicating a number of outliers of the radio wave intensities to a total number of estimated terminal positions of the candidate position group determined for the candidate floor, and
identify, for each of the analysis ranges, one of the candidate floors for which the smallest third ratio has been calculated, as the target floor.

13. The apparatus of claim 8, wherein
the processor is configured to:
for each of the candidate floors and each of analysis ranges that are common to the candidate floors, calculate:
a first ratio of a number of times that the terminal has been moved to an area into which the terminal is not allowed to move, to a total number of estimated terminal positions of the candidate group determined for the candidate floor, based on the movement requirement,
a second ratio of a mean value of time intervals at which the terminal has been detected, to a time period from time when the terminal has started to exist on the candidate floor to time when the terminal has been stopped existing on the candidate floor, and
a third ratio of a number of outliers of the radio wave intensities to a total number of estimated terminal positions of the candidate position group determined for the candidate floor;
obtain a value by summing, for each of the candidate floors and each of the analysis ranges, the first ratio, the second ratio, and the third ratio; and
identify, for each of the analysis ranges, one of the candidate floors for which the smallest value is obtained by summing the first to third ratios, as the target floor.
